(19) United States
(12) Patent Application Publication
(10) Pub. No.: US 2020/0003608 A1
(43) Pub. Date: Jan. 2, 2020

(54) METHOD, VIRTUAL REALITY APPARATUS AND RECORDING MEDIUM FOR MEASURING WEIGHT

(71) Applicant: Chi-Kuei Shen, Taoyuan City (TW)

(72) Inventor: Chi-Kuei Shen, Taoyuan City (TW)

(21) Appl. No.: 16/019,559

(22) Filed: Jun. 27, 2018

(51) Int. Cl. G01G 19/44; G06F 3/0346; G06F 3/01

(52) U.S. Cl. CPC G01G 19/44; G06F 3/011; G06F 3/0346

(57) ABSTRACT

An embodiment of the disclosure provides a method of measuring weight of a user which applied in an electronic apparatus having a sensing unit and a processing unit. The electronic apparatus is implemented by cell phone, tablet, notebook, wearable device etc. The method includes following steps. A motion event of the user is detected by the sensing unit. A magnitude of acceleration resulting from the motion event is obtained by the sensing unit. The magnitude of acceleration is transformed into a user weight according to an acceleration of gravity and a weight of the electronic apparatus by the processing unit. The user weight is outputted by the processing unit.

### BACKGROUND

### Technical Field

The present disclosure relates to a method of measuring and an electronic apparatus thereof, and more particularly relates to a method of measuring weight of a user and an electronic apparatus thereof.

### Description of Related Art

Nowadays, more and more people pay attention to health issue, therefore, health care management becomes quite important. Especially, weight is a basic and important indicator of health care management. Overweight may increase the risk of many health problems, including diabetes, hypertension, sleep apnea, heart disease and so on. On the other hands, underweight may increase the risk of other health problems as well, for example, malnutrition, osteoporosis, loss of attention and so on. In addition, the change of weight may also provide some health information, for example, a person who loss his/her weight fast should do cancer examination. Therefore, weight not only affects but also helps people to understand physical health themselves.

However, a common technique for measuring weight is through standing on a weight scale. Therefore, a way which overcomes the limitation of equipment will be more convenient for people to acquire their weight easily.

### SUMMARY

The invention provides a method of measuring weight of a user and an electronic apparatus thereof so as to measuring the weight of a person who is holding the electronic apparatus (e.g. cell phone, tablet, NB etc) and jumping.

An embodiment of the disclosure provides a method of measuring weight of a user which applied in an electronic apparatus having a sensing unit and a processing unit. The method includes following steps. A motion event of the user is detected by the sensing unit. A magnitude of acceleration resulting from the motion event is obtained by the sensing unit. The magnitude of acceleration is transformed into a user weight according to an acceleration of gravity and an electronic apparatus by the processing unit. The user weight is outputted by the processing unit.

Another embodiment of the disclosure provides an electronic apparatus of measuring weight of a user. The electronic apparatus includes a sensing unit and a processing unit. The sensing unit detects a motion event of a user and obtains a magnitude of acceleration resulting from the motion event. The processing unit coupled to the sensing unit transforms the magnitude of acceleration into a user weight according to an acceleration of gravity and an electronic apparatus. The processing unit then outputs the user weight.

Another embodiment of the disclosure provides a non-transitory computer readable recording medium which records a program loaded by an electronic apparatus to execute the following steps. The electronic apparatus executes following steps. A motion event of the user is detected by a sensing unit. A magnitude of acceleration resulting from the motion event is obtained by the sensing unit. The magnitude of acceleration is transformed into a user weight according to an acceleration of gravity and an electronic apparatus to obtain a user weight by a processing unit. The user weight is outputted by the processing unit.

To sum up, in the method of measuring the user weight and the electronic apparatus (e.g. cell phone, tablet, notebook, wearable device etc.) and the recording medium thereof in the present disclosure, the magnitude of acceleration resulting from the motion event can be obtained and be transformed into the user weight by the electronic apparatus like cell phone, tablet, NB etc. In addition, the convenience of health care management increases because users can record his/her own weight in the electronic apparatus directly after they got their weight.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of an electronic apparatus according to an embodiment of the present disclosure.

FIG. 2 is a flowchart illustrating a method of measuring a weight of a user according to an embodiment of the present disclosure.

FIG. 3 is a block diagram of an electronic apparatus according to another embodiment of the present disclosure.

FIG. 4 is a flowchart illustrating a method of measuring a weight of a user according to another embodiment of the present disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

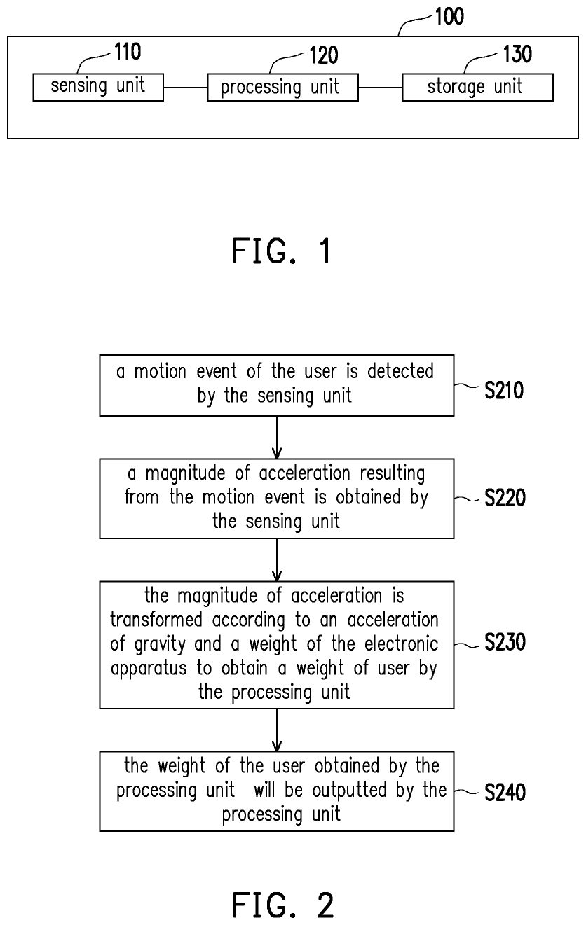

FIG. 1 is a block diagram of an electronic apparatus according to an embodiment of the present disclosure. In the present embodiment, the method of measuring user weight is adapted to the electronic apparatus 100 illustrated in FIG. 1, but the apparatus adaptable for the method is not limited herein.

Referring to FIG. 1, the electronic apparatus 100 includes a sensing unit 110 and a processing unit 120. The sensing unit 110 is configured to detect a motion event of the user who is holding the electronic apparatus 100. Moreover, the sensing unit 110 can obtain the direction and the magnitude of the acceleration resulting from the motion event. The sensing unit 110 may be a capacitive accelerometer, a piezoelectric accelerometer, a piezoresistive accelerometer, a Hall Effect accelerometer, a magnetoresistive accelerometer, a thermal transmission accelerometers, a MEMS accelerometers or nanotechnology accelerometer. Particularly, a G-sensor is applied in this embodiment, but the type of the accelerometer is not limited herein.

The processing unit 120 connected to the sensing unit 110 may include a central processing unit (CPU), a programmable general purpose or special purpose microprocessor, an application specific integrated circuit (ASIC), a field programmable array (FPGA), a programmable logic device (PLD), or other similar devices or a combination thereof. In addition, the processing unit 120 is capable of loading and executing different operations. Specifically, the processing unit 120 can perform a series of operations so as to obtain a user weight of the person who is holding the electronic apparatus 100 according to the magnitude of accelerometer detected by the sensing unit 110. The operation details thereof will be described later in following embodiments.

In an embodiment of the present disclosure, a storage unit 130 is also included in the electronic apparatus 100, which is connected to the processing unit 120 and is configured to store data, modules, applications or programs, and accessible by the processor 120. The storage unit 130 may be, for example, a hard disk drive (HDD), a volatile memory, a non-volatile memory or a combination thereof.

In another embodiment of the present disclosure, the electronic apparatus 100 may further include a display device, a transmission interface or a combination thereof, which are not illustrated in FIG. 1. The electronic apparatus 100 may be a personal computer, a laptop, a tablet computer, a smart mobile device or a wearable electronic apparatus implemented in a form of a sticker, a wristband, a heart rate band, a helmet, a necklace, a watch, a ring, a bracelet, a clothes, or a belt, etc., capable of being worn by the user, but it is not limited thereto. Any electronic apparatus 100 which has the sensing unit 110 and the processing unit 120 can be applied in this disclosure.

FIG. 2 is a flowchart illustrating a method of measuring a weight of a user according to an embodiment of the present disclosure. Referring to FIG. 2, the method of the present embodiment is adapted to the electronic apparatus 100 shown in FIG. 1, but it is not limited herein. The method of the present embodiment is described below with reference of various components and modules of the electronic apparatus 100.

In the present embodiment, the person who wants to measure his/her weight should hold the electronic apparatus 100 and then jump. Therefore, a motion event of the user is detected by the sensing unit 110 (step S210).

Then, a magnitude of acceleration resulting from the motion event is obtained by the sensing unit 110 (step S220). The magnitude of acceleration is transformed according to an acceleration of gravity and a weight of the electronic apparatus to obtain a user weight by the processing unit 120 (step S230). To be more specific, when the user who is holding the electronic apparatus 100 is jumping, first, the user may generate a force opposite to the gravity. When jumping to the highest (i.e. the velocity is zero), the user start to fall because the gravity. In the meantime, the user also causes a force on the electronic apparatus 100 because the user weight is much greater than the electronic apparatus 100. Therefore, the magnitude of acceleration resulting from the motion event (i.e., the magnitude of acceleration detected when the user is falling) is different from the acceleration of gravity. The relationship between the magnitude of acceleration can be illustrated as following equation:

F=(M+m)×g≅M×g=m×G′ (1),

where M is the user weight, m is the weight of the electronic apparatus 100, g is the magnitude of acceleration of gravity and G′ is the magnitude of acceleration resulting from the motion event. Because g and G′ are known, and the weight of the electronic apparatus 100 could be preset in the electronic apparatus 100 or be obtained via internet according to the model number of the electronic apparatus 100. Therefore, the processing unit 120 can transform the magnitude of acceleration resulting from the motion event (G′) according to the magnitude of acceleration of gravity and the weight of the electronic apparatus 100 so as to obtain the unknown user weight through the equation (1).

Then, the user weight obtained by the processing unit 120 is outputted by the processing unit 120 through showing on a display or playing a voice message (step S240).

In one embodiment, a page, software, website or other medium for health care management is provided by the electronic apparatus 100. When the user weight is obtained by the electronic apparatus 100, the user can store the data in the storage unit 130 or a remote storage unit (for example, a remote server) via the medium for health care management to record, observe and manage the health directly. Therefore, the convenience for health care management increases as well.

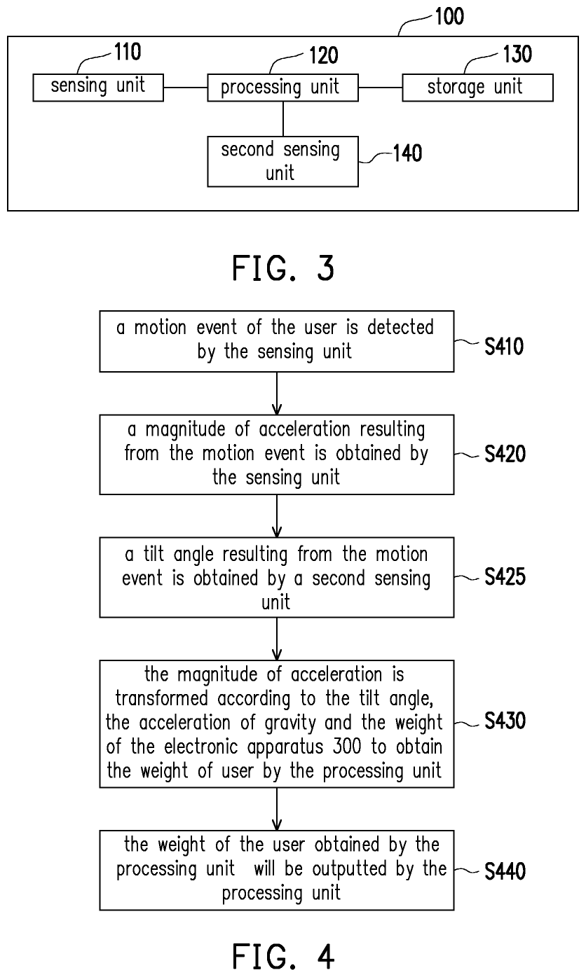

FIG. 3 is a block diagram of an electronic apparatus according to another embodiment of the present disclosure.

Referring to FIG. 3, the electronic apparatus 300 includes a sensing unit 310, a processing unit 320, a storage unit 330 and a second sensing unit 340. The sensing unit 310, the processing unit 320 and the second sensing unit 330 are the same as the sensing unit 110, the processing unit 120 and the second sensing unit 130 presented in FIG. 1. Therefore, no further illustration is provided here. The second sensing unit 340 is configured to detect a tilt angle of the electronic apparatus 300, for example, the second sensing unit can be implemented by a gyro sensor.

FIG. 4 is a flowchart illustrating a method of measuring a weight of a user according to another embodiment of the present disclosure. Referring to FIG. 3 and FIG. 4, the steps S410 and S420 are the same as the steps S210 and S220, and details thereof are not repeated. The difference is that, in the present exemplary embodiment, a tilt angle resulting from the motion event is obtained by a second sensing unit 340 (step S425). To be specific, the user weight is obtained according to the force imposed on the electronic apparatus 300 by the user and the gravity forced on the user and the electronic apparatus 300. Thus, only the forces in the same direction can be interactive to each other (i.e. vertical direction to the ground). The tilt angle can be used to accurately obtain the magnitude of acceleration resulting from the motion event in the vertical component. For example, the processing unit 120 may obtain the magnitude of acceleration caused by the vertical component of the force imposed on the electronic apparatus through multiplying the magnitude of acceleration resulting from the motion event G′ and cosine value of tilt angle (cos θ). However, how to obtain the magnitude of acceleration caused by the vertical component of the force imposed on the electronic apparatus may change according to the way of causing the force imposed on the electronic apparatus, the disclosure is not limited thereto.

Accordingly, the magnitude of acceleration is transformed according to the tilt angle, the acceleration of gravity and the weight of the electronic apparatus 300 to obtain the user weight by the processing unit 320 (step S430). The details thereof is similar to the step S230 in FIG. 2, however, instead of the magnitude of acceleration resulting from the motion event, the vertical component of the magnitude of acceleration resulting from the motion event is adopt for the parameter G′ for increasing accuracy.

The steps S440 is the same as the steps S240, and details thereof are not repeated.

It should be noted that, due to the ability of detecting the acceleration resulting from the motion event are various in different electronic apparatus, an adjusting parameter may be adopted in another embodiment.

To be more specific, the relationship between the magnitude of acceleration can be further adjusted as following equation:

F=(M+m)×g≅M×g=m×G′×Y (2),

where Y is the adjusting parameter.

For example, when the maximum of detecting the acceleration resulting from the motion event is 20G, and the acceleration caused by a person who is 100 kilogram is 50G, the adjusting parameter Y may be set 98. Therefore, the acceleration caused by the person who is 100 kilogram is adjusted from 50G to 20G so as to let the acceleration caused by the person fall within the range which can be detected by the sensing unit.

In an embodiment of the disclosure, when the software is running, the processing unit 320 may adjust the sensitivity of the sensing unit 310 according to the adjusting parameter Y. Thus, the sensing unit 310 may obtain the user weight directly when sensing a magnitude of acceleration resulting from the motion event G′. In a further embodiment, the processing unit 320 may adjust the sensitivity of the sensing unit 310, in the meantime, the storage unit 330 may stores a adjust table. The adjust table includes the magnitude of acceleration resulting from the motion event G′ and corresponding user weight. When obtaining the magnitude of acceleration resulting from the motion event G′, the processing unit 320 finds the corresponding user weight according to the adjust table. The detail of obtaining the user weight according to the adjusting parameter Y is not limit thereto. Besides, the actual value of the adjusting parameter Y may be designed according to a results of a plurality of experiments and the model number of different electronic apparatus, it is not limited thereto. In addition, different values obtained for the acceleration resulting from the motion event may be corresponded to different values of the adjusting parameter Y. The different values of adjusting parameter Y is stored in the storing unit. The adjusting parameter Y can be adopted in the embodiment presented in FIG. 1 to FIG. 4 or other embodiment of present invention.

Thus, in those embodiment adopted the adjusting parameter Y, when a magnitude of acceleration resulting from the motion event is obtained by the sensing unit (for example, step S220, step S420), the magnitude of acceleration is updated by multiplying the adjusting parameter and the magnitude of acceleration resulting from the motion event by the processing unit before obtaining the user weight.

The invention is further directed to a non-transitory computer readable storage medium recording a computer program configured to execute each step of the method for measuring the user weight. The computer program is composed of a plurality of program sections (i.e. building an organization diagram program section, approving a list program section, setting a program section, and deploying a program section). After the program sections are loaded in the electronic apparatus and executed, the steps of the method for measuring the weight can be completed.

In summary, in the method of measuring the user weight and the electronic apparatus and the recording medium thereof in the present disclosure, the magnitude of acceleration resulting from the motion event can be obtained and be transformed into the user weight by the electronic apparatus. Furthermore, for consideration of accuracy, a second sensing unit (for example, gyro sensor) and an adjusting parameter are adopt for correcting magnitude of acceleration resulting from the motion event detected by the electronic device. Therefore, it is not necessary for users to purchase an additional weight scale to measure their weight since electronic apparatus are widely held by people. In addition, the convenience of health care management increases because users can record his/her own weight in the electronic apparatus directly after they got their weight.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A method of measuring weight of a user, applied in an electronic apparatus, the electronic apparatus comprising a sensing unit and a processing unit, the method comprising:
detecting a motion event of the user by the sensing unit;
obtaining a magnitude of acceleration resulting from the motion event by the sensing unit;
transforming the magnitude of acceleration into a user weight according to an acceleration of gravity and a weight of the electronic apparatus by the processing unit; and
outputting the user weight by the processing unit.

2. The method as claimed in claim 1, wherein the electronic apparatus comprising a second sensing unit, and the method further comprising:
obtaining a tilt angle resulting from the motion event by the second sensing unit; and
transforming the magnitude of acceleration according to the tilt angle, the acceleration of gravity and the weight of the electronic apparatus to obtain the user weight by the processing unit.

3. The method as claimed in claim 2, wherein the sensing unit is G sensor, and the second sensing unit is gyro sensor.

4. The method as claimed in claim 1, wherein the electronic apparatus comprising a storage unit which stores an adjusting parameter, and the method further comprising:
updating the magnitude of acceleration by multiplying the adjusting parameter and the magnitude of acceleration resulting from the motion event by the processing unit before obtaining the user weight.

5. An electronic apparatus of measuring weight of a user, comprising:
a sensing unit, detecting a motion event of the user and obtaining an magnitude of acceleration resulting from the motion event; and
a processing unit, coupled to the sensing unit, transforming the magnitude of acceleration into a user weight according to an acceleration of gravity and a weight of the electronic apparatus and outputting the user weight.

6. The electronic apparatus as claimed in claim 5, further comprising:
a second sensing unit, coupled to the processing unit, obtaining a tilt angle resulting from the motion event,
wherein the processing further transforming the magnitude of acceleration according to the tilt angle, the acceleration of gravity and the weight of the electronic apparatus to obtain the user weight by the processing unit.

7. The electronic apparatus as claimed in claim 5, wherein the sensing unit is G sensor, and the second sensing unit is gyro sensor.

8. The electronic apparatus as claimed in claim 5, further comprising: a storage unit, coupled to the processing unit, storing an adjusting parameter,
wherein the processing unit updating the magnitude of acceleration by multiplying the adjusting parameter and the magnitude of acceleration resulting from the motion event before obtaining the user weight.

9. A non-transitory computer readable recording medium, recording a program to be loaded by an electronic apparatus to execute steps of:
detecting a motion event of a user by a sensing unit;
obtaining an magnitude of acceleration resulting from the motion event by the sensing unit;
transforming the magnitude of acceleration into a user weight according to an acceleration of gravity and a weight of the electronic apparatus by a processing unit; and
outputting the user weight by the processing unit.

10. The non-transitory computer readable recording medium as claimed in claim 9, further recording the program to be loaded by the electronic apparatus to execute steps of:
obtaining a tilt angle resulting from the motion event by a second sensing unit; and
transforming the magnitude of acceleration according to the tilt angle, the acceleration of gravity and the weight of the electronic apparatus to obtain the user weight by the processing unit.
